(19) United States
(12) Patent Application Publication
(10) Pub. No.: US 2024/0355017 A1
(43) Pub. Date: Oct. 24, 2024

(54) Text-Based Real Image Editing with Diffusion Models

(71) Applicant: Google LLC, Mountain View, CA (US)

(72) Inventors: Shiran Elyahu Zada, Tel Aviv (IL); Bahjat Kawar, Nazareth (IL); Oran Lang, Ramat Gan (IL); Omer Tov, Kadima-Zoran (IL); Huiwen Chang, Jersey City, NJ (US); Tali Dekel, Arlington, MA (US); Inbar Mosseri, Raanana (IL)

(21) Appl. No.: 18/302,508

(22) Filed: Apr. 18, 2023

(51) Int. Cl. G06T 11/60; G06T 3/40

(52) U.S. Cl. CPC G06T 11/60; G06T 3/4053

(57) ABSTRACT

Methods and systems for editing an image are disclosed herein. The method includes receiving an input image and a target text, the target text indicating a desired edit for the input image and obtaining, by the computing system, a target text embedding based on the target text. The method also includes obtaining, by the computing system, an optimized text embedding based on the target text embedding and the input image and fine-tuning, by the computing system, a diffusion model based on the optimized text embedding. The method can further include interpolating, by the computing system, the target text embedding and the optimized text embedding to obtain an interpolated embedding and generating, by the computing system, an edited image including the desired edit using the diffusion model based on the input image and the interpolated embedding.

### FIELD

The present disclosure relates generally to digital image editing. More particularly, the present disclosure relates to applying text-based semantic edits to an image using only an input image and a target text by leveraging a text-to-image diffusion model.

### BACKGROUND

Applying non-trivial semantic edits to real photos has been a challenge in image processing. Many methods for text-based image editing suffer from drawbacks, such as being limited to a specific set of edits (such as painting over an image, adding an object, or transferring style), operating only on images from a specific domain or synthetically generated images, or requiring auxiliary inputs in addition to the input image, such as image masks indicating the desired edit location, multiple images of the same subject, or a text describing the original image.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for editing an image. The method includes receiving, by a computing system, an input image and a target text, the target text indicating a desired edit for the input image and obtaining, by the computing system, a target text embedding based on the target text. The method also includes obtaining, by the computing system, an optimized text embedding based on the target text embedding and the input image and fine-tuning, by the computing system, a diffusion model based on the optimized text embedding. The method further includes interpolating, by the computing system, the target text embedding and the optimized text embedding to obtain an interpolated embedding and generating, by the computing system, an edited image including the desired edit using the diffusion model based on the input image and the interpolated embedding.

Another example aspect of the present disclosure is directed to a computing system for editing images. The computing system includes one or more processors and a non-transitory, computer-readable medium comprising instructions that, when executed by the one or more processors, cause the one or more processors to perform operations. The operations include receiving an input image and a target text, the target text indicating a desired edit for the input image and obtaining a target text embedding based on the target text. The operations also include obtaining an optimized text embedding based on the target text embedding and the input image and fine-tuning a diffusion model based on the optimized text embedding. TH operations further include interpolating the target text embedding and the optimized text embedding to obtain an interpolated embedding and generating an edited image including the desired edit using the diffusion model based on the input image and the interpolated embedding.

Another example aspect of the present disclosure is directed to a non-transitory, computer-readable medium comprising instructions that, when executed by one or more processors, cause the one or more processors to perform operations. The operations include receiving an input image and a target text, the target text indicating a desired edit for the input image and obtaining a target text embedding based on the target text. The operations also include obtaining an optimized text embedding based on the target text embedding and the input image and fine-tuning a diffusion model based on the optimized text embedding. The operations further include interpolating the target text embedding and the optimized text embedding to obtain an interpolated embedding and generating an edited image including the desired edit using the diffusion model based on the input image and the interpolated embedding.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example image editing model according to example embodiments of the present disclosure.

FIG. 2 depicts examples of an image editing process according to example embodiments of the present disclosure.

FIG. 3 depicts results of different random noise samples being input into a fine-tuned diffusion model according to example embodiments of the present disclosure.

FIG. 4 depicts varying a value for a hyperparameter can result in different edited images according to example embodiments of the present disclosure.

FIG. 5 depicts a flow chart diagram of an example method for performing image editing according to example embodiments of the present disclosure.

FIG. 6A depicts a block diagram of an example computing system that performs image editing according to example embodiments of the present disclosure.

FIG. 6B depicts a block diagram of an example computing device that performs image editing according to example embodiments of the present disclosure.

FIG. 6C depicts a block diagram of an example computing device that performs image editing according to example embodiments of the present disclosure.

Reference numerals that are repeated across plural figures are intended to identify the same features in various implementations.

### DETAILED DESCRIPTION

### Overview

Generally, the present disclosure is directed to semantic image editing given only an input image to be edited and a single text prompt describing the target edit.

Text-to-diffusion models use diffusion models that are capable of high-quality image synthesis. When conditioned on natural language text prompts, diffusion models are able to generate images that align well with the requested text. The present invention adapts diffusion models to edit real images instead of synthesizing new images.

This is performed in a three-step process. First, a text embedding is optimized so that it results in a text embedding that best matches the given input image in the vicinity of the target text embedding. Second, diffusion models are fine-tuned to better match or reconstruct the given input image. Finally, the optimized embedding and the target text embedding are linearly interpolated in order to find a point that achieves both fidelity to the image and target text alignment.

The above-described method of editing images allows for sophisticated, non-rigid edits on real high-resolution images. The resulting image outputs align well with the target text while preserving the overall background, structure, and composition of the original image. For example, an input image of a dog standing along with text “a dog laying down” results in an output of the dog (same fur color, same background, same expression, same features, and the like) in a new pose (laying down instead of standing). Multiple objects in the image can be edited, and a wide variety of edits can be performed, all while preserving the overall structure and composition of the original image.

Additionally, the present invention allows a semantically meaningful linear interpolation between two text embedding sequences to be generated, which illustrates the strong compositional capabilities of text-to-image diffusion models and allows the user to gradually edit the objects in the image.

With reference now to the Figures, example embodiments of the present disclosure will be discussed in further detail.

### Example Model Arrangements

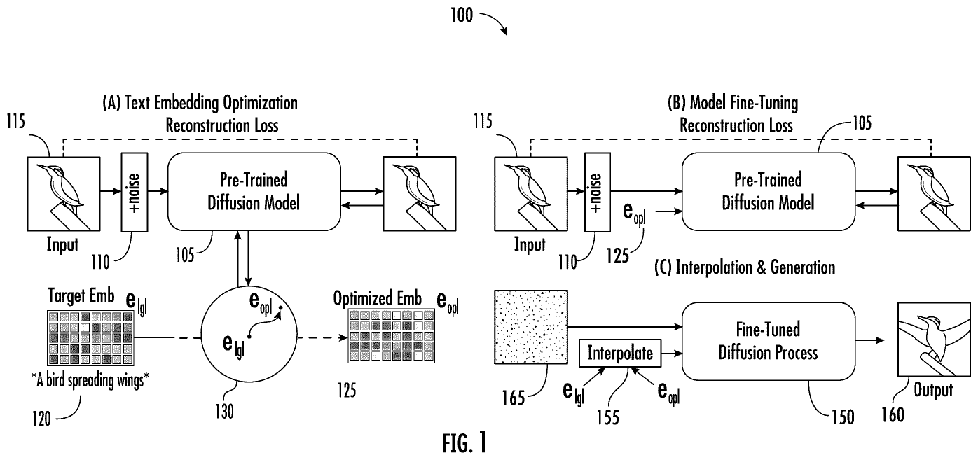

FIG. 1 depicts a block diagram of an example image model 100 according to example embodiments of the present disclosure.

The image editing model 100 includes a pre-trained diffusion model 105. The core premise of the pre-trained diffusion model is to initialize with a randomly sampled noise image (such as randomly sampled noise image 110) and then iteratively refine that image in a controlled fashion until it is synthesized into a photorealistic image that is “clean,” or includes no artifacts from the generation process. Each refinement step can include an application of a neural network on a current sample followed by random Gaussian noise perturbation, which obtains a more defined sample. The network is trained for denoising, which leads to a learned image distribution with high fidelity to the target distribution. These models can be generalized for learning conditional distributions by conditioning the denoising network on an auxiliary input, and the resulting diffusion process can sample from a data distribution conditioned on the auxiliary input. In some embodiments, the auxiliary input can be a text sequence that describes the desired image. By incorporating knowledge from large language models or hybrid vision-language models, these text-to-image diffusion models can generate realistic high-resolution images using only a text prompt describing the scene. A low-resolution image is first synthesized using generation diffusion, and then is transformed into a high-resolution image using additional auxiliary models.

The present invention takes an input image (such as input image 115) that represents a real object, animal, person, or the like and a target text that describes the desired edit as inputs. The eventual goal of the pre-trained model 105 is to edit the input image in a way that satisfies the given text while preserving a maximum amount of detail from the input image (e.g., small details in the background and the identity of the object within the image). To accomplish this, a text embedding layer of the pre-trained diffusion model 105 can be used to perform semantic manipulations. This is performed by finding meaningful representation which, when fed through the generative process, yields images similar to the input image 115. The pre-trained model 105 is then fine-tuned to better reconstruct the input image 115 and then finally the latent representation is manipulated to obtain the edited result.

To begin, text embedding optimization can be performed. Text embedding optimization includes passing the target text through a text encoder, which outputs a corresponding target text embedding 120. The output target text embedding can indicate a number of tokens in the target text and have a token embedding dimension.

Parameters of the pre-trained diffusion model 105 are then frozen and the target text embedding 120 is optimized using a denoising diffusion objective, such as the objective shown in Equation 1.

$$L ( x , e , Θ ) = {E}_{t , ϵ} [ {‖ ϵ - {f}_{θ} I ( {x}_{t} , t , e ) ‖}_{2}^{2} ] \qquad Equation 1$$

In Equation 1, xₜ is a noisy version of the input image and theta is the set of pre-trained diffusion model weights. The resulting optimized text embedding 125 is the text embedding that matches the input image as closely as possible (e.g., as shown in embedding distance 130). In some embodiments, this process is performed for relatively few steps in order to remain close to the initial target text embedding 120 when obtaining the optimized test embedding 125. This optimized text embedding does not necessarily lead to the input image x exactly when passed through the generative diffusion process, as the optimization runs for a small number of steps. This proximity enables meaningful interpolation in the embedding space, which does not exhibit linear behavior for distant embeddings.

Next, the pre-trained diffusion model 105 is fine-tuned. Because the optimization to obtain the optimized text embedding 125 is run for a small number of steps, model parameters theta of the pre-trained diffusion model 105 are optimized using the same loss function as shown in Equation 1 while freezing the optimized text embedding 125. This process shifts the pre-trained diffusion model 105 to fit the input image 115 at the point of the optimized text embedding 125. In parallel, auxiliary diffusion models present in the underlying generative model can be fine-tuned with the same reconstruction loss as the pre-trained diffusion model 105, but by being conditioned on the target text embedding 120 instead of the optimized text embedding 125. The optimization of the auxiliary models ensures the perseveration of high-frequency details from the input image 115 that are not present in the base resolution.

After the pre-trained diffusion model 105 is trained to fully recreate the input image 115 at the optimized embedding 125, the newly created fine-tuned diffusion model 150 (e.g., the trained and fine-tuned pre-trained diffusion model 105) is used to apply the desired edit to the input image 115 by advancing in the direction of the target text embedding 120. In other words, this stage of the process is a simple linear interpolation 155 between the target text embedding 120 and the optimized text embedding 125. For a given hyperparameter η∈[0, 1] Equation 2 can be used to obtain the embedding representing the desired edited image.

$$\underline{e} = η \cdot {e}_{tgt} + ( 1 - η ) \cdot {e}_{opt} \qquad Equation 2$$

In Equation 2, e_{tgt} is the target text embedding 120 and eₒₚₜ is the optimized text embedding 125. The output of Equation 2 is the embedding that represents the desired edited image. The fine-tuned diffusion model 150 applies the base generative diffusion process (conditioned on e), which results in a low-resolution edited image 160. The low-resolution edited image 160 is super-resolved using the fine-tuned auxiliary models (conditioned on the target text), which outputs the final high-resolution edited image.

In some embodiments, the framework of the pre-trained diffusion model 105 and the fine-tuned diffusion model 150 can include three different text-conditioned diffusion models: a generation diffusion model for 64×64 pixel images, a super-resolution diffusion model turning 64×64 pixel images into 256×256 pixel images, and a second super-resolution diffusion model that transforms 256×256 pixel images in 1024×1024 pixel images. By cascading these three models and using classifier-free guidance, the pre-trained diffusion model 105 and the fine-tuned diffusion model 150 can generate image edits based on text guidance from the target text.

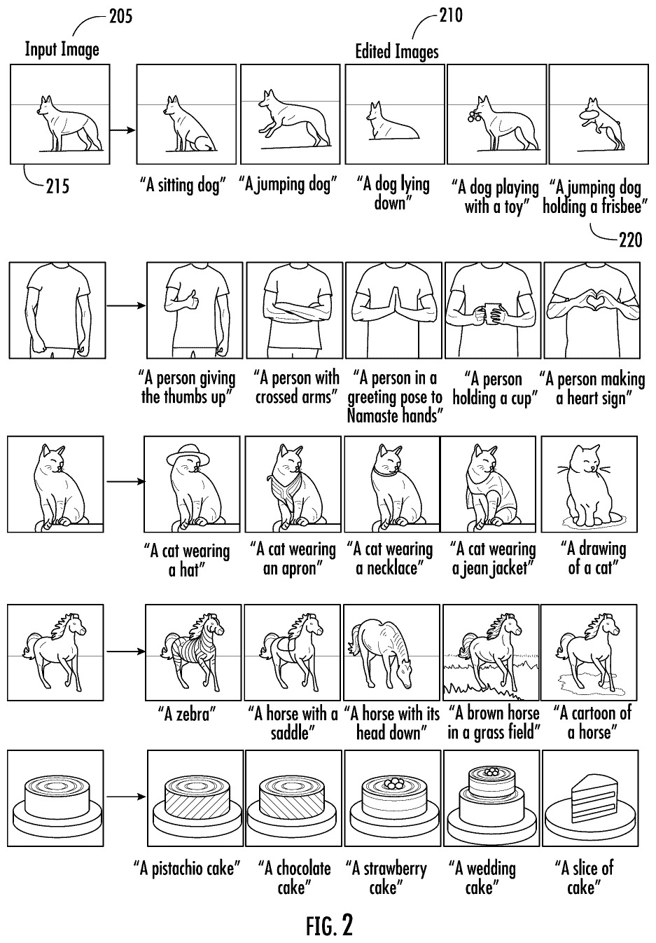

Examples of the image editing process can be found in FIG. 2. For example, based on an input image (such as any of input images 205), the fine-tuned diffusion model 150 can be fine-tuned for the particular input image, which results in output various edited images (such as any of edited images 210) based on a target text input associated with the desired image edit. In one example, input dog image 215 of a dog standing in a field can be provided with one of desired image edit target texts 220, such as “a sitting dog,” “a jumping dog,” “a dog lying down,” and the like. Note that in certain target texts, such as “a dog playing with a toy” or “a jumping dog holding a frisbee,” new objects can be added as well as edits to currently present objects being performed. Other examples of input images 205 and resulting edited images 210 are also shown to illustrate other types of edits that can be performed on various input images.

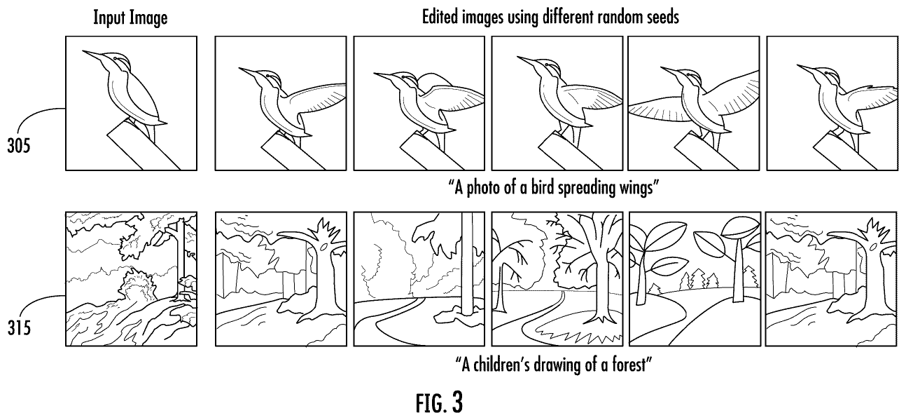

Returning now to FIG. 1, in some embodiments, the final output image 160 can be different based on the random noise 165 input into the fine-tuned diffusion model 150. For example, FIG. 3 illustrates the results 305 of different random noise samples being input into the fine-tuned diffusion model 150. Given first input image 310 of a bird resting with its wings down with the target text being “a photo of a bird spreading wings,” different noise samples can result in the different output results 305. A second example of a second input image 315 of a forest along with target text of “A children's drawing of a forest” is also provided to show how the random noise sample 165 can result in different final output images 160.

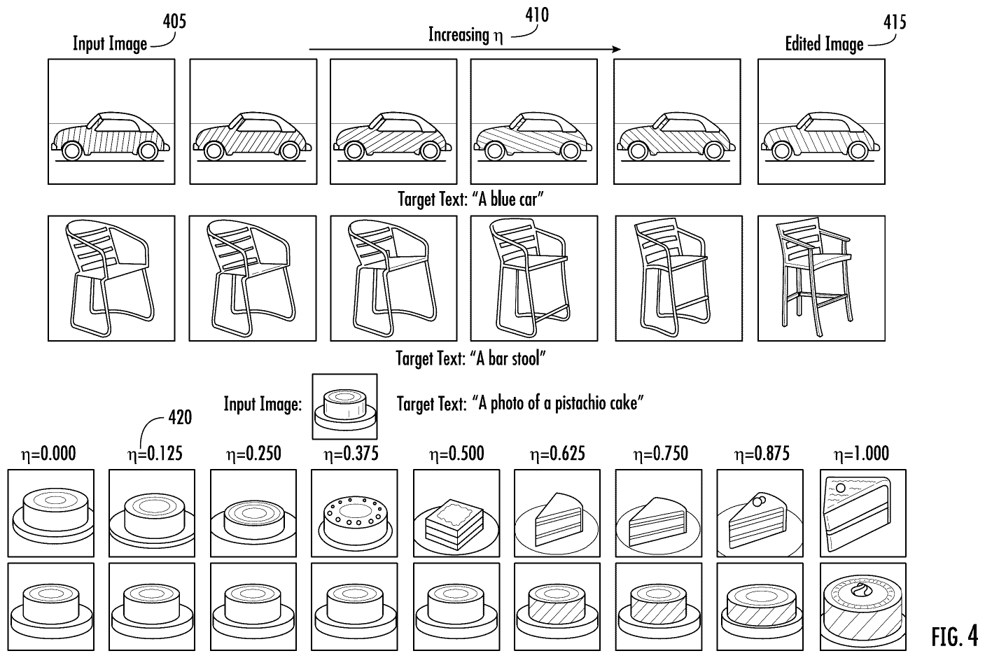

In some embodiments, the value for hyperparameter q can result in different edited images. For example, FIG. 4 illustrates how varying the value 410 for hyperparameter q can result in different edited images 415 based on given input image 405. In a second example, specific and different η values 420 can lead to different generated results based on an input image of a cake and a target text of “a photo of a pistachio cake.”

### Example Methods

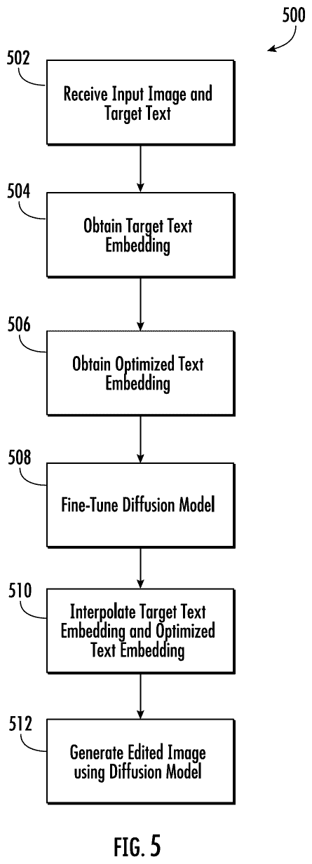

FIG. 5 depicts a flow chart diagram of an example method 500 to perform an image edit according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system receives an input image and a target text, the target text indicating a desired edit for the input image. The target text is a text presentation of the desired edit, such as “A dog sitting down” being provided with an input image that shows a dog standing in a field. The input image is the basis on which the edited image will be generated (e.g., keeping details from the input image) while performing the desired edit as indicated by the target text.

At 504, the computing system obtains a target text embedding based on the target text. The target text embedding is a text embedding that represents the target text in an embedding that is usable by one or more models. In some embodiments, the computing system obtains the target text embedding by providing the target text to a text encoder and receiving, as output from the text encoder, the target text embedding. In some embodiments, the target text embedding includes a number of tokens in the target text and has a token embedding dimension.

At 506, the computing system obtains an optimized text embedding based on the target text embedding and the input image. To obtain the optimized text embedding, parameters of a diffusion model are frozen and the target text embedding is optimized using a denoising decoding objective, which can be a loss function such as the function described in Equation 2 above. The resulting text embedding represents the input image as closely as possible. This optimizing process is run for a predetermined number of steps (relatively few) in order to remain close to the initial target text embedding. The resulting embedding after the number of steps is run is the optimized text embedding. The optimized text embedding enables a meaningful linear interpolation in the embedding space, which does not exhibit linear behavior for distant embeddings. The optimized text embedding does not necessarily lead to the input image exactly when passed through a diffusion model, as the optimization runs for a small number of steps.

At 508, the computing system fine-tunes a diffusion model based on the optimized text embedding. To fine-tune the diffusion model, the optimal text embedding is frozen and model parameters of the diffusion model are optimized using the frozen optimal text embedding. To optimize the model parameters, a loss function is used. This process shifts the model to fit the input image x at the point of the optimized text embedding. In some embodiments, optimizing the parameters of the model can include conditioning the diffusion model on the optimized text embedding.

In some embodiments, fine-tuning the diffusion model can also include fine-tuning at least one auxiliary diffusion model, such as a super-resolution generative diffusion model. Fine-tuning the auxiliary diffusion model can be similar to fine-tuning the diffusion model. For example, fine-tuning the auxiliary diffusion model can include using the same loss function as the diffusion model to optimize one or more parameters of the auxiliary diffusion model, but instead of freezing the optimized text embedding and conditioning the auxiliary diffusion model on the optimized text embedding, the target text embedding is frozen instead and the auxiliary diffusion model is conditioned on the target text embedding. The optimization of the auxiliary diffusion model on the target text embedding ensures the preservation of high-frequency details from the input image that are not present in a base resolution that is generated by the diffusion model.

At 510, the computing system interpolates the target text embedding and the optimized text embedding to obtain an interpolated embedding. The diffusion model is fully and strictly trained (e.g., overfit) to fully recreate the input image at the optimized embedding. Therefore, to apply the desired edit, the computing system begins at the optimized embedding and moves in the embedding space towards the target text embedding to generate the edit. To “move in the direction” of the target text embedding, a simple linear interpolation (as described by Equation 2 disclosed above) is performed between the optimized text embedding and the target text embedding. In some embodiments, this interpolation is represented by the hyperparameter |. An interpolated embedding is obtained based on the linear interpolation of the optimized text embedding, the target text embedding and the hyperparameter.

At 512, the computing system generates an edited image including the desired edit using the diffusion model based on the input image and the interpolated embedding. The fine-tuned diffusion model then performs a base generative diffusion process conditioned on the interpolated embedding to obtain a low-resolution image (e.g., a 64×64 pixel image) that contains the desired edit. In some embodiments, the one or more auxiliary diffusion models, such as super-resolution models, can then be used to super-resolve the low-resolution image into a high-resolution final image (e.g., a 256×256 and/or a 1024×1024 pixel image), which is then output as the final edited image.

### Example Devices and Systems

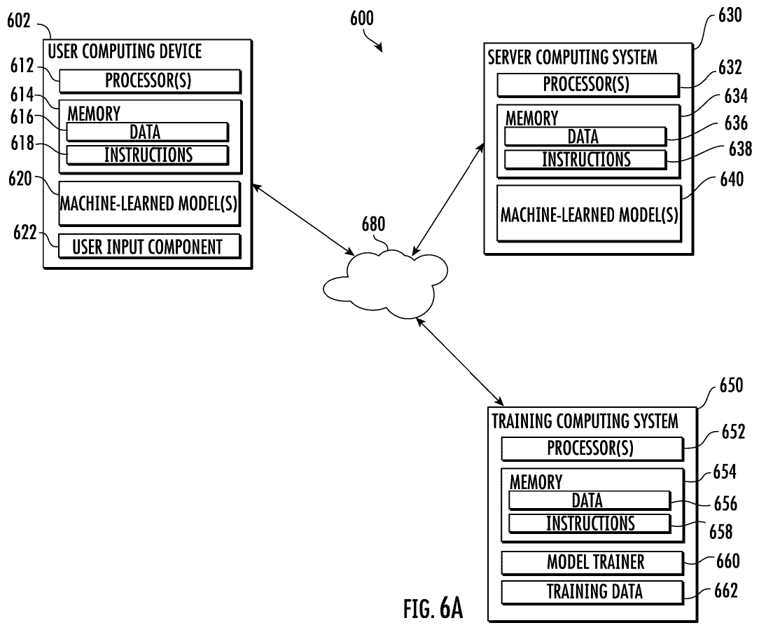

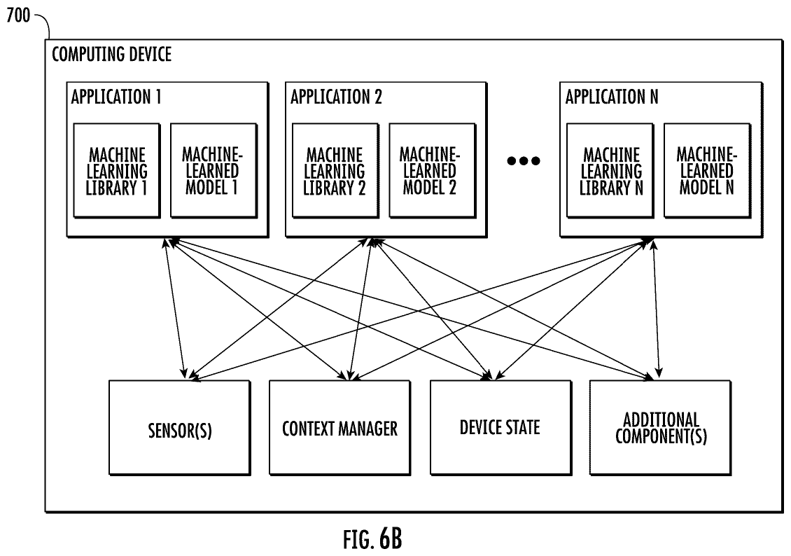

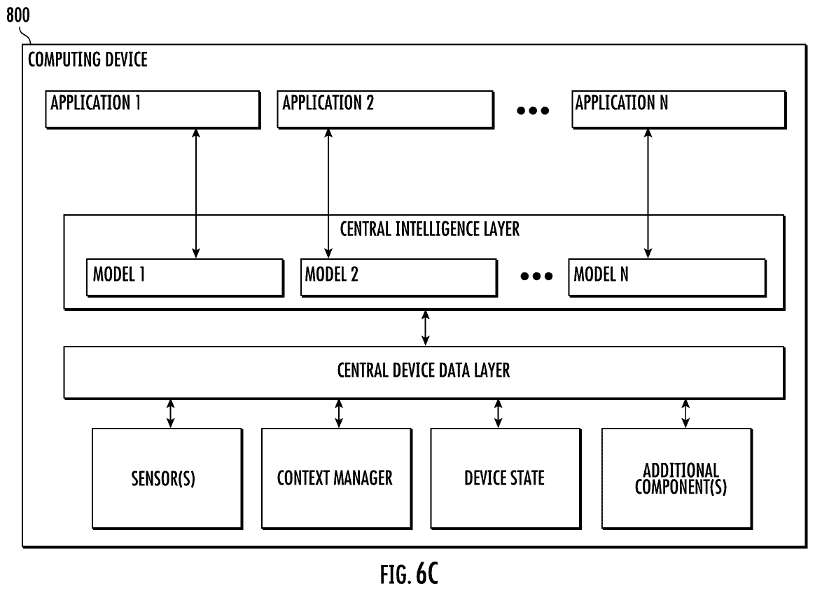

FIG. 6A depicts a block diagram of an example computing system 600 that performs image editing according to example embodiments of the present disclosure. The system 600 includes a user computing device 602, a server computing system 630, and a training computing system 650 that are communicatively coupled over a network 180.

The user computing device 602 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 602 includes one or more processors 612 and a memory 614. The one or more processors 612 can be any suitable processing device (e.g., a processor core, a microprocessor, an ASIC, an FPGA, a controller, a microcontroller, etc.) and can be one processor or a plurality of processors that are operatively connected. The memory 614 can include one or more non-transitory computer-readable storage media, such as RAM, ROM, EEPROM, EPROM, flash memory devices, magnetic disks, etc., and combinations thereof. The memory 614 can store data 616 and instructions 618 which are executed by the processor 612 to cause the user computing device 602 to perform operations.

In some implementations, the user computing device 602 can store or include one or more image editing models 620. For example, the image editing models 620 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example image editing models 620 are discussed with reference to FIG. 1.

In some implementations, the one or more image editing models 620 can be received from the server computing system 630 over network 180, stored in the user computing device memory 614, and then used or otherwise implemented by the one or more processors 612. In some implementations, the user computing device 602 can implement multiple parallel instances of a single image editing model 620 (e.g., to perform parallel image editing across multiple instances of image editing).

More particularly, given an input image and a target text indicating a desired edit to the image, the one or more image editing models 620 can edit the image in a way that satisfies the given text while preserving a maximum amount of detail from the original input image, such as small details in the background, details about not-edited portions of one or more objects, and the like. The one or more models 620 then uses the text embedding layer of the one or more models to perform semantic manipulations on the input image to obtain a latent representation of the input image, which can then be manipulated to obtain an output image with the desired edit specified by the given text.

Additionally or alternatively, one or more image editing models 640 can be included in or otherwise stored and implemented by the server computing system 630 that communicates with the user computing device 602 according to a client-server relationship. For example, the image editing models 640 can be implemented by the server computing system 640 as a portion of a web service (e.g., an image editing service). Thus, one or more models 620 can be stored and implemented at the user computing device 602 and/or one or more models 640 can be stored and implemented at the server computing system 630.

The user computing device 602 can also include one or more user input components 622 that receives user input. For example, the user input component 622 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 630 includes one or more processors 632 and a memory 634. The one or more processors 632 can be any suitable processing device (e.g., a processor core, a microprocessor, an ASIC, an FPGA, a controller, a microcontroller, etc.) and can be one processor or a plurality of processors that are operatively connected. The memory 634 can include one or more non-transitory computer-readable storage media, such as RAM, ROM, EEPROM, EPROM, flash memory devices, magnetic disks, etc., and combinations thereof. The memory 634 can store data 636 and instructions 638 which are executed by the processor 632 to cause the server computing system 630 to perform operations.

In some implementations, the server computing system 630 includes or is otherwise implemented by one or more server computing devices. In instances in which the server computing system 630 includes plural server computing devices, such server computing devices can operate according to sequential computing architectures, parallel computing architectures, or some combination thereof.

As described above, the server computing system 630 can store or otherwise include one or more image editing models 640. For example, the models 640 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 640 are discussed with reference to FIG. 1.

The user computing device 602 and/or the server computing system 630 can train the models 620 and/or 640 via interaction with the training computing system 650 that is communicatively coupled over the network 180. The training computing system 650 can be separate from the server computing system 630 or can be a portion of the server computing system 630.

The training computing system 650 includes one or more processors 652 and a memory 654. The one or more processors 652 can be any suitable processing device (e.g., a processor core, a microprocessor, an ASIC, an FPGA, a controller, a microcontroller, etc.) and can be one processor or a plurality of processors that are operatively connected. The memory 654 can include one or more non-transitory computer-readable storage media, such as RAM, ROM, EEPROM, EPROM, flash memory devices, magnetic disks, etc., and combinations thereof. The memory 654 can store data 656 and instructions 658 which are executed by the processor 652 to cause the training computing system 650 to perform operations. In some implementations, the training computing system 650 includes or is otherwise implemented by one or more server computing devices.

The training computing system 650 can include a model trainer 660 that trains the machine-learned models 620 and/or 640 stored at the user computing device 602 and/or the server computing system 630 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 660 can perform a number of generalization techniques (e.g., weight decays, dropouts, etc.) to improve the generalization capability of the models being trained.

In particular, the model trainer 660 can train the image editing models 620 and/or 640 based on a set of training data 662. The training data 662 can include, for example, input images for one or more of the editing models 620 and 640. In some embodiments, the editing models 620 and 640 can include a generative diffusion model for 64×64 pixel images, a first super-resolution diffusion model for transforming 64×64 pixel images into 256×256 pixel images, and a second super-resolution diffusion model for transforming 256×256 pixel images into 1024×1024 pixel images. Text embeddings for the image editing models 620 and 640 can be optimized during training using the 64×64 diffusion model. In some embodiments, an Adam optimizer with 100 sets and a fixed learning rate of 1e-3 can be used. The 64×64 diffusion model can then be fine-tuned by continuing training for 1500 steps on the input image conditioned on the optimized embedding. In parallel the first super-resolution diffusion model can be fine-tuned using the target text embedding and the original image for 1500 steps in order to capture high-frequency details from the input image.

In another embodiment, the image editing models 620 and 640 can be trained by applying the diffusion process in a latent space of size 4×64×64 of a pre-trained autoencoder working on 512×512 images with optimizing of a text embedding taking 1000 steps with a learning rate of 2e-3 using Adam.

Based on this training, the text embeddings can be interpolated according to Equation 3 described above with regards to FIG. 1. Because of the fine-tuning process, as q increases, the output image aligns with the target text. For example, if η is 0, the original image will be generated, and if η is 1, a completely new image (e.g., sharing no characteristics with the input image) will be generated. In some embodiments, η can be in between 0.6 and 0.8. The output image can then be generated using the image editing models 620 or 640.

In some implementations, if the user has provided consent, the training examples can be provided by the user computing device 602. Thus, in such implementations, the model 620 provided to the user computing device 602 can be trained by the training computing system 650 on user-specific data received from the user computing device 602. In some instances, this process can be referred to as personalizing the model.

The model trainer 660 includes computer logic utilized to provide desired functionality. The model trainer 660 can be implemented in hardware, firmware, and/or software controlling a general purpose processor. For example, in some implementations, the model trainer 660 includes program files stored on a storage device, loaded into a memory and executed by one or more processors. In other implementations, the model trainer 660 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

FIG. 6A illustrates one example computing system that can be used to implement the present disclosure. Other computing systems can be used as well. For example, in some implementations, the user computing device 602 can include the model trainer 660 and the training dataset 662. In such implementations, the models 620 can be both trained and used locally at the user computing device 602. In some of such implementations, the user computing device 602 can implement the model trainer 660 to personalize the models 620 based on user-specific data.

FIG. 6B depicts a block diagram of an example computing device 700 that performs according to example embodiments of the present disclosure. The computing device 700 can be a user computing device or a server computing device.

The computing device 700 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 6B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 6C depicts a block diagram of an example computing device 800 that performs according to example embodiments of the present disclosure. The computing device 800 can be a user computing device or a server computing device.

The computing device 800 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 6C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 800.

The central intelligence layer can communicate with a central device data layer. The central device data layer can be a centralized repository of data for the computing device 800. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for editing an image, the method comprising:
receiving, by a computing system, an input image and a target text, the target text indicating a desired edit for the input image;
obtaining, by the computing system, a target text embedding based on the target text;
obtaining, by the computing system, an optimized text embedding based on the target text embedding and the input image;
fine-tuning, by the computing system, a diffusion model based on the optimized text embedding;
interpolating, by the computing system, the target text embedding and the optimized text embedding to obtain an interpolated embedding; and
generating, by the computing system, an edited image including the desired edit using the diffusion model based on the input image and the interpolated embedding.

2. The computer-implemented method of claim 1, wherein obtaining the target text embedding includes
providing, by the computing system, the target text to a text encoder; and
receiving, by the computing system, the target text embedding from the text encoder.

3. The computer-implemented method of claim 1, wherein obtaining the optimized text embedding includes
freezing, by the computing system, the parameters of the diffusion model;
optimizing, by the computing system, the target text embedding using a denoising diffusion objective to obtain the optimized text embedding;
and outputting the optimized text embedding, wherein the optimized text embedding is a text embedding that matches the input image.

4. The computer-implemented method of claim 1, wherein fine-tuning the diffusion model includes
freezing, by the computing system, the optimized text embedding; and
optimizing, by the computing system, at least one model parameter of the diffusion model using a loss function.

5. The computer-implemented method of claim 4, wherein optimizing the at least one model parameter includes conditioning the diffusion model on the optimized text embedding.

6. The computer-implemented method of claim 4, wherein fine-tuning the diffusion model further includes
fine-tuning, by the computing system, at least one auxiliary diffusion model, wherein fine-tuning the at least one auxiliary diffusion model includes
freezing, by the computing system, the target text embedding; and
optimizing, by the computing system, the at least one auxiliary diffusion model using the loss function.

7. The computer-implemented method of claim 6, wherein optimizing the at least one auxiliary diffusion model includes conditioning the at least one auxiliary diffusion model on the target text embedding.

8. The computer-implemented method of claim 6, wherein generating the edited image includes
generating, by the computing system, a low-resolution version of the edited image using the diffusion model;
super-resolving, by the computing system, the low-resolution version of the edited image into a final high-resolution version of the edited image using the at least one auxiliary diffusion model.

9. The computer-implemented method of claim 1, wherein generating the edited image includes
generating, by the computing system, the edited image using the diffusion model conditioned on the interpolated embedding.

10. A computing system for editing images, the computing system comprising:
one or more processors; and
a non-transitory, computer-readable medium comprising instructions that, when executed by the one or more processors, cause the one or more processors to perform operations, the operations comprising:
receiving an input image and a target text, the target text indicating a desired edit for the input image;
obtaining a target text embedding based on the target text;
obtaining an optimized text embedding based on the target text embedding and the input image fine-tuning a diffusion model based on the optimized text embedding;
interpolating the target text embedding and the optimized text embedding to obtain an interpolated embedding; and
generating an edited image including the desired edit using the diffusion model based on the input image and the interpolated embedding.

11. The computing system of claim 10, wherein obtaining the target text embedding includes providing the target text to a text encoder; and
receiving the target text embedding from the text encoder.

12. The computing system of claim 10, wherein obtaining the optimized text embedding includes
freezing, by the computing system, the parameters of the diffusion model;
optimizing, by the computing system, the target text embedding using a denoising diffusion objective to obtain the optimized text embedding;
and outputting the optimized text embedding, wherein the optimized text embedding is a text embedding that matches the input image.

13. The computing system of claim 10, wherein fine-tuning the diffusion model includes
freezing the optimized text embedding; and
optimizing at least one model parameter of the diffusion model using a loss function.

14. The computing system of claim 13, wherein optimizing the at least one model parameter includes conditioning the diffusion model on the optimized text embedding.

15. The computing system of claim 13, wherein fine-tuning the diffusion model further includes
fine-tuning at least one auxiliary diffusion model, wherein fine-tuning the at least one auxiliary diffusion model includes
freezing the target text embedding; and
optimizing the at least one auxiliary diffusion model using the loss function.

16. The computing system of claim 15, wherein optimizing the at least one auxiliary diffusion model includes conditioning the at least one auxiliary diffusion model on the target text embedding.

17. The computer-implemented method of claim 15, wherein generating the edited image includes
generating a low-resolution version of the edited image using the diffusion model;
super-resolving the low-resolution version of the edited image into a final high-resolution version of the edited image using the at least one auxiliary diffusion model.

18. The computing system of claim 10, wherein generating the edited image includes
generating the edited image using the diffusion model conditioned on the interpolated embedding.

19. A non-transitory, computer-readable medium comprising instructions that, when executed by one or more processors, cause the one or more processors to perform operations, the operations comprising:
receiving an input image and a target text, the target text indicating a desired edit for the input image;
obtaining a target text embedding based on the target text;
obtaining an optimized text embedding based on the target text embedding and the input image;
fine-tuning a diffusion model based on the optimized text embedding;
interpolating the target text embedding and the optimized text embedding to obtain an interpolated embedding; and
generating an edited image including the desired edit using the diffusion model based on the input image and the interpolated embedding.

20. The non-transitory, computer-readable medium of claim 19, wherein generating the edited image includes
generating the edited image using the diffusion model conditioned on the interpolated embedding.
